(19) United States
(12) Patent Application Publication
(10) Pub. No.: US 2009/0098501 A1
(43) Pub. Date: Apr. 16, 2009

(54) DENTAL RETRACTION DEVICE, METHOD OF PRODUCTION AND USE THEREOF

(76) Inventors: Thomas Klettke, Diessen (DE); Ruediger Hampe, Wessling (DE); Robert F. Peez, Landsberg (DE); Jens Gramann, Munich (DE); Marc Peuker, Schondorf (DE); Helmut Pauser, Diessen (DE)

Correspondence Address: 3M INNOVATIVE PROPERTIES COMPANY, PO BOX 33427, ST. PAUL, MN, 55133-3427, US

(21) Appl. No.: 12/295,109

(22) PCT Filed: Mar. 29, 2007
(86) PCT No.: PCT/US07/65442

§ 371 Date: Sep. 29, 2008

(30) Foreign Application Priority Data
Mar. 31, 2006 (EP) 06006815.2
Jul. 26, 2006 (EP) 06015551.2

(51) Int. Cl. A61C 3/00

(52) U.S. Cl. 433/8; 433/7

(57) ABSTRACT

The invention relates to a dental retraction device to be used for retracting the gingiva from a prepared tooth structure, the retraction device having the shape of a cord with a radial (x- and y-direction) and longitudinal direction (z-direction) and comprising an absorbing agent and optionally a retarding agent, wherein the retraction device is able to expand in the radial direction (x- and/or y-direction), but essentially does not expand in the longitudinal direction (z-direction) upon contact with fluid.

### FIELD OF THE INVENTION

The invention relates to a dental retraction device and its use for retracting the gingiva from a prepared tooth.

### BACKGROUND OF THE INVENTION

A common method for providing horizontal and vertical retraction is by use of a retraction cord. Thus, a length of retraction cord is packed between gingival tissue and the margin of the prepared tooth by use of an appropriate dental instrument e.g. with a Heinemann spatula. It is often necessary to pack several lengths of retraction cord into the sulcus in order to obtain sufficient vertical and horizontal retraction of gingival tissue to be able to make an impression having excellent marginal detail.

Retraction cords of the state of the art mostly consist of knitted cellulose. The cords have a limited capacity of absorbing fluids which would be necessary to clean the area in order to take better impressions.

A description of the background in regard to retraction cords can be found inter alia in U.S. Pat. No. 4,522,593.

The Journal of Prosthetic Dentistry, 1996, Vol. 75, pages 242 to 247 reports on tissue management using a synthetic material called Merocel™ as a retraction material.

US 2005/0069838 relates to a dental kit and method for retraction sulcus using an expanding silicone compound or mixture of different silicone compounds.

U.S. Pat. No. 4,871,311 describes a retraction method using a retraction cord made at least in part of an externally accessible super absorbent swelling material.

### SUMMARY OF THE INVENTION

Retraction devices of the state of the art often do not expand sufficiently to conform to surfaces of the gingival mucosa.

In order to at least partially address this problem, the invention provides a dental retraction device to be used for retracting the gingiva from a prepared tooth structure, the retraction device having the shape of a cord with a radial (x- and y-direction) and longitudinal direction (z-direction) and comprising an absorbing agent and optionally a retarding agent, wherein the retraction device is able to expand in the radial direction (x- and/or y-direction), but essentially does not expand in the longitudinal direction upon contact with fluid.

The invention also relates to a kit of parts comprising a retraction device and a curable impression material, the setting behaviour of which is not negatively affected, if cured in the presence of the retraction device.

In another aspect the invention relates to a kit of parts comprising a retraction device and an initiator solution.

In a further aspect, the invention also relates to methods of producing a dental retraction device.

In another aspect the invention relates to a method of using a polyvinyl alcohol derivative for producing a dental retraction device.

### DEFINITIONS

A component or material is characterized as “expandable” within the meaning of the invention, if it is able to undergo an increase in size and volume (x-, y- and/or z-direction). This can be caused by contacting the component or material with another substance, e.g. a fluid, which is able to migrate into the component or material.

A device is characterized as being “radial expandable” if it can change its radial shape in one (x- or y-direction) or two dimensions (x- and y-direction). Thus, an expansion in shape in only one dimension can fall within the term “radial expandable”, as well.

A device is characterized as being “expandable in one dimension”, if it can change its dimensions in only one dimension (e.g. y-direction) and does essentially not change its dimensions in the other two dimensions (e.g. x- and z-direction).

A “tooth structure” within the meaning of the invention is any tooth structure, prepared or ready for preparation by the dentist. It can be a single tooth or two or more teeth.

“Fluid” within the meaning of the invention shall comprise especially biological fluid, e.g., liquids which are present in a patient's mouth like saliva and blood or a mixture of both. Those liquids are mainly comprised of water.

An agent is characterized as being “absorbing” within the meaning of the invention, if the agent is able on contact with fluid to suck up a certain amount of the fluid from the surroundings. This usually goes along with an increase in size and volume of the absorbing substance.

A material or substance is characterized as “flexible” within the meaning of the invention if its 3-dim shape can be altered when applying an external force either manually or with the help of another device or by gravity. A cord is characterized as “flexible” within the meaning of the invention, if it is possible to bend the cord in all directions without undue burden according to the practitioners needs.

A “haemostatic agent” within the meaning of the invention is an agent which is able to reduce bleeding to a certain amount and/or causes blood to coagulate.

“Anti-microbial agents” within the embodiment of the invention may be all anti-microbial compounds, especially those compatible with non-aqueous elastomeric dental materials like polyether containing impression materials.

A “softening agent” within the meaning of the invention is an agent or additive, which can be added to a composition or material, in order to reduce stiffness. This may be accompanied by a smoother surface compared to the composition or material not comprising a softening agent. The addition of a softening agent can result in a slippery surface, especially if a huge amount (e.g. more than about 10 wt.-% with respect to the weight of the retraction device) is added.

“Delayed expansion” with in the meaning of the invention is to be understood as an expansion of the retraction device which takes place after a certain period of time upon contact with a fluid, especially oral fluids such as saliva and/or blood.

A “retarding agent” within the meaning of the invention is an agent causing or resulting in a delay of the change of a parameter such as expansion in volume or change in shape of the retraction device.

An “initiator solution” within the meaning of the invention is a solution compensating or inhibiting the retarding effect caused by the retarding agent and enabling or accelerating the retraction device to start absorbing fluid. With a well adapted initiator solution a retraction device expanding on demand can be provided.

The term “essentially does not” within the meaning of the invention is to be understood that a certain—sometimes unavoidable—effect does usually not take place or only occurs to a minimum amount, wherein the effect does not negatively affect the overall result to be achieved. E.g., an expansion in length of a substance of less than about 20% or less than about 10% is considered as essentially not having taken place.

The setting behaviour of a curable composition is “not negatively affected” within the meaning of the invention, if the setting of the curable composition takes place within the given specification. Small deviations (e.g. within a range of about 5 to 10%) of physical parameters like Shore hardness, viscosity, working time or setting time, which might occur if e.g. an additive is added or setting takes place in conjunction with other materials or substances (e.g. in the presence of a retraction device), are not considered detrimental.

As used herein, “a”, “an”, “the”, “at least one” and “one or more” are used interchangeably. The terms “comprises” or “contains” and variations thereof do not have a limiting meaning where these terms appear in the description and claims. Also herein, the recitations of numerical ranges by endpoints include all numbers subsumed within that range (e.g., 1 to 5 includes 1, 1.5, 2, 2.75, 3, 3.80, 4, 5, etc.).

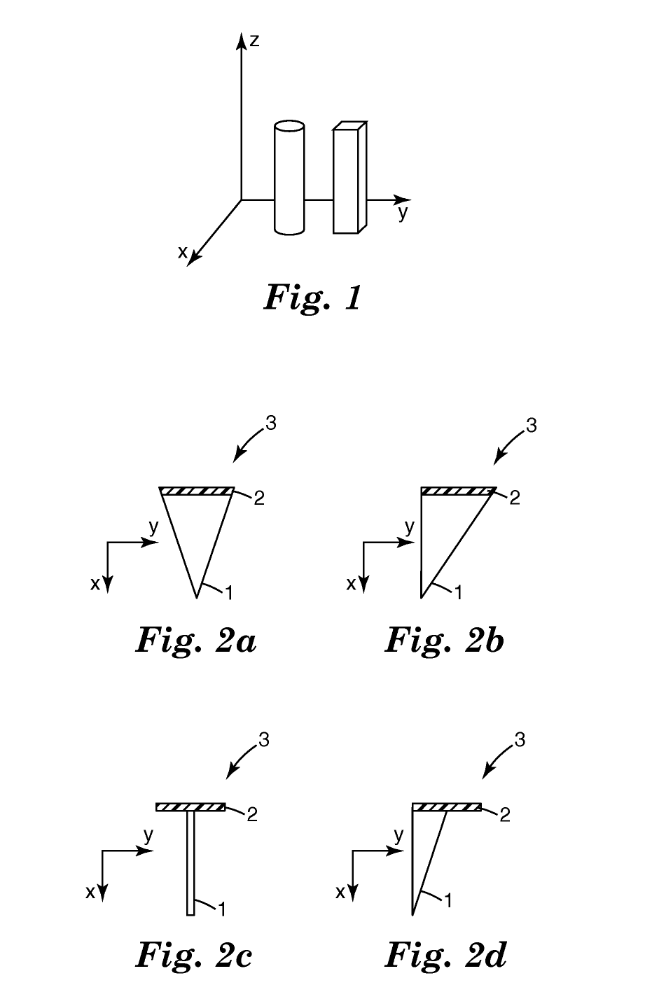

A more detailed description of certain embodiments is provided herein below with reference to FIGS. 1 to 7.

FIG. 1 shows retraction devices of the invention expanding in x and y direction.

FIGS. 2a-2d show useful cross-sectional shapes of the retraction device according to the invention.

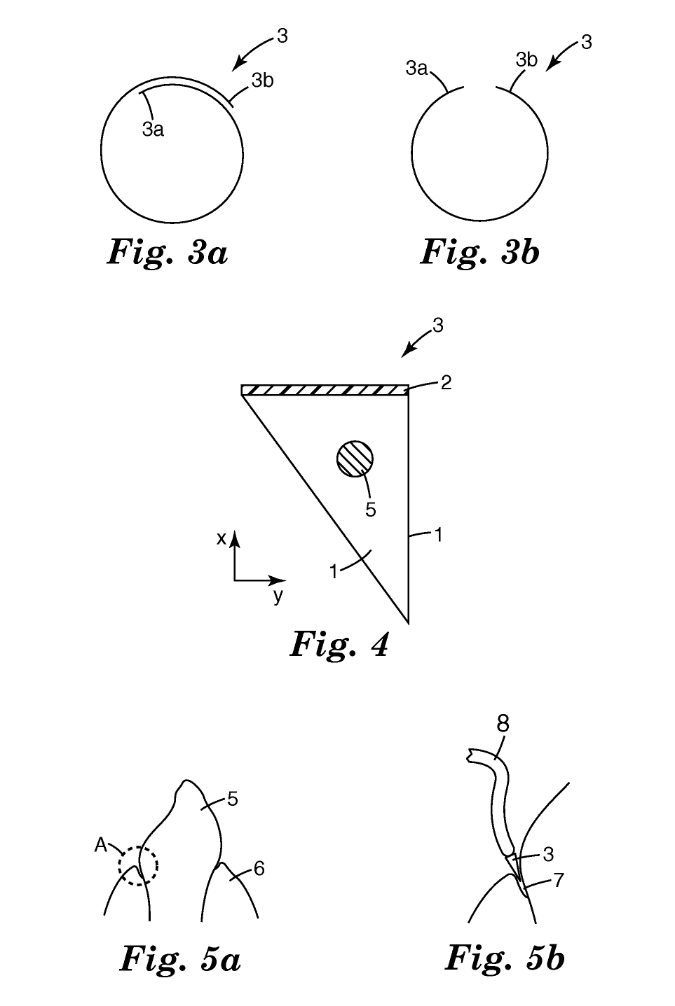

FIGS. 3a and 3b show useful shapes of the retraction device according to the invention in z-direction.

FIG. 4 shows a particular retraction device according to the invention in cross section.

FIGS. 5a and 5b show a possible use of the retraction device according to the invention.

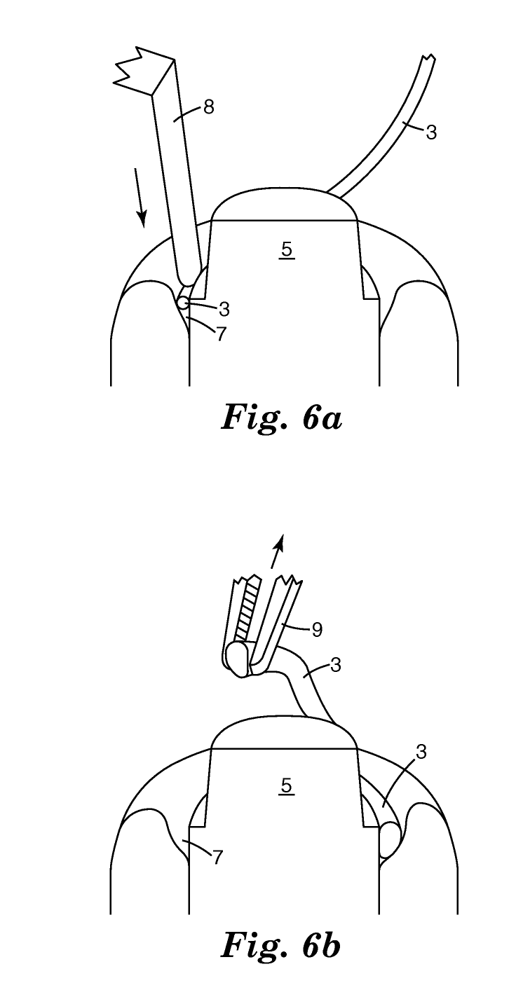

FIGS. 6a and 6b show the use of another embodiment according to the invention.

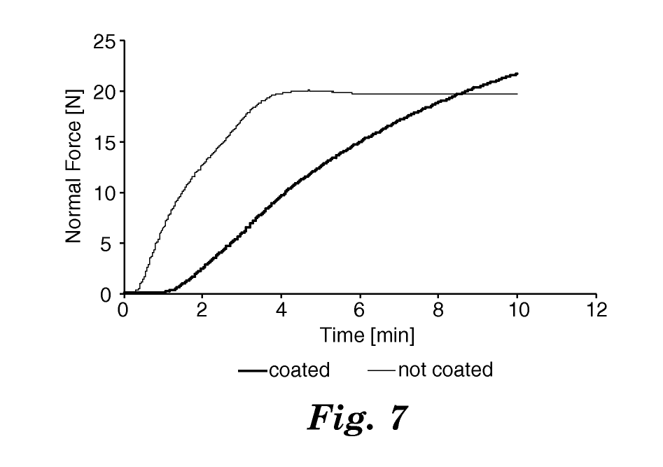

FIG. 7 shows a graph exemplifying the delayed expansion versus not delayed expansion.

### DETAILED DESCRIPTION OF THE INVENTION

In one embodiment, the retraction device of the invention is able to expand in radial direction (x- and y-direction) when contacted with moisture or fluid. Examples are given in FIG. 1 for e.g. square or cylindrical shaped devices.

According to another embodiment of the invention, the retraction device essentially expands in the presence of moisture in y-direction only. There is no or only minor expansion in z- (longitudinal) and x-direction.

If possible, shrinkage in the longitudinal direction should be avoided, since this could result in contraction and incomplete coverage of the area around the prepared margin.

Expansion in the longitudinal direction is also undesirable as a cord which expands in length could be forced out of the gingival sulcus. In other words the cord essentially keeps its length but expands in radial direction in the presence of moisture or fluid. This expansion is caused by the uptake of fluids, like saliva and/or blood.

However, it can be useful if the retraction device shows a resilient behaviour in the longitudinal direction.

When contacted with fluid, the retraction device should preferably show a delayed expansion.

A delayed expansion can facilitate the application of the device into the sulcus. If the delay is too short, the retraction device starts expanding too fast and it becomes very difficult to place the expanded retraction device into the tight gap between gingiva and hard tooth structure. If the delay is too long, the overall impression taking procedure is delayed and might cause pain for the treated patient.

A delay of at least about 5 s or at least about 30 s or at least about 60 s is considered sufficient, wherein the delay period is determined starting from the initial contact of the retraction device with fluid. For dental application sufficient expansion without mechanical load of the retraction device should be completed within a time period of about 10 min or about 5 min or about 1 min or about 50 s or about 40 s or about 30 s or about 20 s.

A delayed expansion can be achieved using a retraction device comprising an absorbent agent and a retarding agent.

The retarding agent can be incorporated into or dispersed in the retraction device, especially into the absorbing agent or it can be placed on the surface of the retraction device or the absorbing agent. It can also be incorporated into the retraction device and placed on the surface of the retraction device. The incorporation can be homogeneously or heterogeneously, wherein a homogeneous distribution is preferred.

Incorporation of the retarding agent into or placing of the retarding agent on the surface of the retraction device can be accomplished by dipping the retraction device into a solution containing the retarding agent or by soaking the retraction device with a solution containing the retarding agent. It is also possible to spray a solution of the retarding agent onto the surface of the retraction device or to coat the surface of the retraction device with the retarding agent.

An example for a typical process for producing such a retraction device comprises the steps of a) providing a solution of a retarding agent, b) providing a sample of a retraction device and c) dipping the retraction device into the solution of a), e.g. for at least about 1 or at least about 5 s or at least about 10 s, d) drying the retraction device, e.g. for at least about 2 minutes to about 5 hours or for about 2 to about 4 hours at a temperature of about 20° C. to about 30° C. The dipping and drying step can be repeated as appropriate.

The concentration of the retarding agent in the solution is typically within a range of about 0.5 wt.-% to about 10 wt.-% or to about 20 wt.-% or to about 30 wt.-% with respect to the weight of the retraction device without a retarding agent. Solvents which can be used include ketones including acetone, alcohols including ethanol or water or mixtures of those.

If the retarding agent is placed on the surface of the retraction device or the absorbing agent, the thickness of the layer of the retarding agent is typically below about 0.5 mm or below about 0.1 mm or below about 0.05 mm.

Upon contact with fluid, the retarding agent is starting to dissolve or is washed from the surface of the retraction device or eluted.

Retarding agents which can be used include film forming agents based on sugar, polyacrylates, methacrylates, gum arabic, gelatines, methylcellulose, other cellulose derivatives or polyethylene glycols.

Substances which are already used in the pharmaceutical industry because of their proven biocompatibility are generally preferred. Polymers, in particular those with an average molar mass greater than about 10,000 are preferred as well.

Specific examples include:

Naturally film forming agents including natural shellac, mastix (pistachio resin), sandarac (resin of callitris quadrivalvis), tolubalsam (resin of Myroxylon balsamum), dammar resin (cat eye resin, resin of the dammar tree), benzoe resin (asiatic resin), keratin, maizin (protein from maize seeds), gum Arabic and gelatines.

Semi-synthetic film forming agent including semi-synthetic gelatines treated with formaldehyde and salol (acetaldehyde-phenol-condensate).

Cellulose and derivatives of cellulose including cellulose acetate, hydroxyethyl cellulose, methyl cellulose, hydroxypropyl cellulose, sodium-carboxymethyl cellulose, ethyl cellulose and hydroxypropylmethyl cellulose phthalate.

Poly(meth)acrylates including copolymers of methacrylic and amino-functional methacrylates and copolymers of (meth)acrylic acid and methymethacrylate.

Vinylpolymers including vinyl polyvinyl pyrrolidon polymers and polyvinyl acetate phthalate.

Typical representatives of poly(meth)acrylates include Eudragit™ types manufactured by Röhm, Darmstadt company including Eudragit™ L (acid-resistant; acid groups-functional polymer), Eudragit™ E (acid soluble; amino groups-functional polymer).

Compounds based on cellulose derivatives (such as OPADRY™ II, manufactured by Colorcon, or Sepifilm™, manufactured by Seppic) or copolymers, which contain polysaccharides, such as e.g. Surelease™ (by Colorcon) can also be used.

In a specific embodiment, the retarding agent is either soluble in acidic solutions, or soluble in alkali solutions or soluble in water or soluble in alcoholic solutions or soluble in organic solvents.

Especially preferred are Eudragit™ E coatings which are soluble in an acidic environment at pH-values below about 6 or below about 5 and alcohol containing solutions. Examples of solvents which can be used to for diverse types of Eudragit™ are described in product information brochure by Degussa Pharma Polymers in more detail and can be downloaded from the respective home page. Examples for such alcoholic solutions include methanol, ethanol, iso-propanol, methyl glycol, butyl glycol, acetone, methyl ethyl ketone, Cyclohexanone, methylen chloride, ethyl acetate, butyl acetate, toluol and methyl glycol acetate.

To control the solubility in the desired pH-range the use of a mixture of different retarding agents e.g. different types of Eudragit™ can be useful.

Furthermore, additives to modify the physical and/or chemical properties of the retarding agent can be added or incorporated. For instance, if the retarding agent is present on the surface of the retraction device (e.g. coated on the absorbing agent) the flexibility of the retarding agent layer can be improved by the addition of softening agents (including e.g. acetyltriethylcitrat, triethylcitrat, tributylcitrat, acetyltributylcitrat, dibutylsebacat, polyethylenglycol, polypropylenglycol). It's also possible to add dyes and/or pigments to the retarding agent.

In another embodiment of the invention the expansion of the retraction device comprising an absorbing agent and a retarding agent is initiated by an initiator solution.

E.g., if the retarding agent is in the form of a coating which is soluble in an acidic solution, the initiator solution can be an acid containing solution having a pH-value below about 6 or below about 5. In this respect, the initiator solution might accelerate dissolving of the coated substance in the moist acidic environment compared to a neutral environment. Depending on the chemical nature of the retarding agent, the dissolving process can also be accelerated using neutral initiator solutions, e.g. solutions comprising organic solvents like ketons (including acetone) and alcohols (including ethanol) and mixtures of water with those.

Examples of initiating solutions which can be used include: acetic acid containing solutions (e.g. containing about 15% wt.-% acetic acid), hydrochloric acid containing solutions (e.g. containing about 1 mol/l HCl), hexahydrated aluminium chloride containing solutions (e.g. containing about 25 g hexahydrated aluminium chloride/100 ml solvent), aluminium sulphate containing solutions (e.g. containing about 25 g aluminium sulphate/100 ml solvent), iron chloride containing solutions (e.g. containing about 15 g iron sulphate/100 ml solvent) and mixture of ethanol/water (e.g. volume ratio 40/60).

Ideally common retraction solutions for haemostasis can be used as initiator solution. Commercially available solutions typically contain about 25 g Al₂(SO₄)₃ per 100 ml solvent (e.g. Orbat Sensitive™ by Lege artis, Dettenhausen) or about 25 g AlCl₃*6H₂O per 100 ml solvent (e.g. Racestyptine™ by Septodont, Saint-Maur-des-Fossés) or about 15 g Fe₂(SO₄)₃ per 100 ml solvent (e.g. Astingedent™ by Ultradent, South Jordan Utah). Alcoholically epinephrine containing solutions can be used as well.

Thus, the invention is also directed to a kit comprising the retraction device (comprising the absorbing agent and the retarding agent) and an initiator solution. The initiator solution is typically stored until use in conventional devices such as bottles.

The shape (especially the cross sectional shape) of the retraction device is not particularly limited as long as the intended use can be achieved. However, it has been found that certain geometrical shapes and/or structures may allow for an easy placement of the retraction device in the sulcus especially in combination with an application tool such as a spatula.

The retraction device is shaped like a cord and is preferably flexible in nature. Unlike pastes, a cord can be removed from the sulcus in a standard procedure e.g. with the aid of a pincer.

In one embodiment the retraction device has an essentially cylindrical or rectangular shape.

The retraction device can be up to about 10 cm long. However, even a shorter version can be preferred such as about 1 cm, e.g. if only a small region of the sulcus has to be retracted. Generally, the retraction device has a length in the range of about 1 to about 15 cm or about 5 to about 10 cm or about 2 to about 5 cm.

The diameter of the retraction device (in the non-absorbent status) is not particularly limited, either, but is usually in the range of about 0.1 to about 4 mm or about 0.2 to about 2 mm. In other embodiments the diameter of the retraction device does not exceed values above about 1 mm or about 0.5 mm.

The diameter of the retraction device after having been contacted with fluid (in the absorbent status) can reach values up to about 0.5 mm or up to about 1 mm or up to about 2 mm or up to about 4 mm or even up to about 6 mm. Sometimes values up to about 10 mm can be achieved.

The ratio of longitudinal expansion to radial expansion (especially with respect to length) can be greater than 1 to about 10 or greater than about 1 to about 20 or even greater than about 1 to about 50.

In another embodiment the retraction device has a non-cylindrical shape and can thus be divided in different portions. The first portion of the device may have properties being different from the properties of the second portion with regard to geometry and/or physical and/or chemical properties, e.g. with regard to shape, elasticity, hardness, pore volume and/or absorbing property.

The portion of the retraction device which is applied in the sulcus can be tight or slim (portion 1), whereas the opposite site of the device, which can be touched with an application tool and which remains visible when inserted into the sulcus, often has a wider or extended, predominantly flat surface area (portion 2).

A retraction device with two different portions can be made by covering the first portion with the second portion, which can be a layer of a material being different from the material of the first portion. The second portion can be fixed or attached to the second portion e.g. using and adhesive or by laminating both materials. If needed, additional layers of material can be attached.

A retraction device being comprised of two portions with different properties may allow for an easy placement of the device in the sulcus of a patient using an application instrument such as a Heinemann spatula.

In a further embodiment, the second portion comprises a material like a textile material (e.g. woven or non-woven fabric) such as cotton. In another embodiment the second portion comprises the same material with regard to the chemical nature as of the first portion but with different physical properties like e.g. expansion properties or pore volume.

In another embodiment, the second portion has a different colour compared to the first portion. This allows for an easy application of the device in the right direction. Alternatively or in addition other features allowing to distinguish the different portions from each other, e.g. a different texture, may be applied.

In a further embodiment, retraction devices comprising a first and a second portion expand in one dimension only.

Examples of shapes which have been found to be useful for an inventive retraction device are given in FIGS. 2a-2d. In FIGS. 2a-2d only the cross sectional area (x- and y-direction of a coordinate system) is shown. In FIGS. 2a-2d, the retraction device is identified as (3), the first portion is identified as (1) and the second portion is identified as (2).

Alternatively or in addition, the shape of the inventive retraction device can be characterized as comprising essentially two sites or areas, an apical site and a coronal site.

The apical site of the retraction device usually has a smaller width (in y-direction) than the coronal site. The apical site is applied into the sulcus and can have a width (in y-direction) of about 0.2 to about 0.5 mm. The coronal site opposite the apical site can have a width (in y-direction) of about 0.5 to about 1.0 mm.

The coronal site of the retraction device may have a different colour than the apical site.

The cross section of the retraction device can have the shape of a triangle (right-angled, equilateral or asymmetric), the shape of a wedge, the shape of a “T” or mixtures of these shapes. In a preferred embodiment the corpus of the device has a triangular shaped cross sectional area such that the whole device has the shape of an elongated or stretched prism.

In a further embodiment, the cord-shaped retraction device can be curled or coiled with respect to the z-direction, either with overlapping or open ends. Thus, the retraction device may have an open or closed ring-like structure, however, without the front and the rear end of the retraction device being fixed together. In contrast to a closed loop or circle, a retraction device pre-shaped as mentioned above is more flexible in use and may allow for a more convenient placement of the device round the tooth structure and into the sulcus to be treated compared to a not pre-shaped retraction device, especially if the retraction device has a more rigid morphology. Examples for this embodiment are shown in FIGS. 3a and 3b. Numbers (3a) and (3b) indicate the front and rear end of the retraction device (3).

Providing a retraction device with a customized shape can be advantageous for adjusting the expansion of the device in the desired direction (which is usually the y-direction according to FIGS. 2a-2d). This can be an effective way to displace the gingiva from the tooth structure. For certain clinical indications an one-dimensional expansion (y-direction) of the retraction device can be an advantage. For other clinical indications a two-dimensional expansion (x- and y-direction) of the retraction device might be preferred.

Selecting a certain shape—being different from a cylindrical or rectangular shape—may also allow for providing a larger volume of the retraction device, especially with regard to absorbing capacity.

If the length of the retraction device in x-direction (height) is longer than the depth of the sulcus of the tooth, the retraction device is able to not only dry the wet sulcus but also the outer part of the tooth structure around the preparation which can be advantageous prior to impression taking.

The shape of the edges connecting the corners of the cross section of the retraction device is not particularly limited. Pointed, concave or convex shapes are possible. The shape of the corners of the retraction device are not particularly limited, either. However, a rounded shape is preferred.

The expansion of the retraction device in radial direction (x- and/or y-direction) when soaked in deionized water for 1 minute without load can reach values above about 100% or above about 150% or above about 200% related to the diameter of the dry retraction device.

The expansion of the retraction device in longitudinal direction (z-direction) of the retraction device when soaked in deionized water for 1 minute without load usually does not exceed a value of about 30% or does not exceed a value of about 20% or does not exceed a value of about 10% related to the diameter of the dry retraction device.

A useful water uptake of the absorbing agent of the retraction device when soaked in deionized water for about 1 min without load can reach a value above about 400 wt.-%, or even above about 500 wt.-% related to the weight of the dry absorbing agent of the retraction device.

In one embodiment the absorbing agent of the retraction device is able to absorb up to about 1 ml or up to about 0.5 ml or up to about 0.2 ml of fluid.

The overall volume expansion (including radial and longitudinal expansion) of the absorbing agent can be above about 50% or above about 70% or above about 100% or above about 200% relative to the original volume measured without external load.

The swelling or expanding process of the retraction device when contacted with fluid or moisture usually goes along with development of a force. From a clinical point of view it can be advantageous if the retraction device exerts a certain force onto a given tissue area to achieve sufficient retraction. The resistance of a given tissue area to an applied pressure can clinically be estimated making a dental impression of the tissue area to be analysed using a modified full arch tray which is equipped with an adjustable force-way-analyser. With the help of such an analyser, which can be positioned at the outer site of the tray, the force to distort the tissue can be measured.

Thus, in a preferred embodiment, the inventive retraction device should provide, exert or develop—during or at the end of expanding process—a pressure with respect to the gingival tissue which is strong enough to widen the sulcus (hereinafter referred to as swelling pressure). The nature of the sulcus, however, varies from patient to patient.

It has been found that a pressure of at least about 10 kPa or of at least about 50 kPa or of at least about 100 kPa or of at least about 200 kPa can be sufficient for the intended use. The upper limit of the pressure which can be developed by the retraction device is not particularly limited, however, it has been found that the pressure does usually not exceed a value of about 500 kPa or of about 1000 kPa or of about 1500 kPa. The retraction device should be able to maintain a sufficiently high pressure as long as the retraction procedure lasts (usually about 1 to about 15 min or about 2 to about 10 min). Thus, useful ranges of the pressure which can be exerted by the retraction device are e.g. from about 10 kPa to about 1500 kPa or from about 50 kPa to about 1000 kPa or from about 100 kPa to about 500 kPa.

These values can be determined measuring the pressure a defined sample of a retraction device (length=20.0 mm, width=2.0 mm, height=0.3 mm) develops when soaked with a defined amount of water (5 ml) between parallel plates (diameter 20 mm, gap distance 0.5 mm) of a dynamic stress rheometer. A more detailed measurement method is given below.

It is within the scope of the invention to use retraction devices having any desired properties like length, diameter, expansion and absorption behaviour.

The fully expanded dimension will be determined by the dimensions of the body opening into which the retraction device is to be inserted.

Thus, if not otherwise indicated, the above mentioned values relate to parameters in respect to a retraction device in an “un-limited” i.e. open volume without external load or other restriction (testing under “in vitro” conditions). Under “in vivo” conditions, that is, if the retraction device is placed in the sulcus of teeth, the values can differ significantly in view of the fact that the sulcus restricts the retraction device from a complete expansion.

If the retraction device is flexible, easy placement in the gingival sulcus using a common device like a Heinemann spatula is possible.

The absorbing agent may be a uniform body or may be comprised of particles that are in contact with each other, e.g. they may be adhesively fixed to each other.

The absorbing agent can have the shape of a sponge, a solid foam or a woven or non-woven fabric. The absorbing agent preferably comprises an open-pored material. The predominant amount of pores of the sponge should preferably be arranged in radial direction with respect to the longitudinal axis of the retraction device.

It has been found that dental retraction devices comprising absorbing agents as mentioned above having a shape being different from fibres made out of e.g. cotton can be more easily removed from the sulcus after use without leaving residues of material which might cause tissue irritations or complications, like bleeding or inflammation of the treated tissue.

In another embodiment the retraction device can comprise an inner section and an outer section, wherein the inner section comprises a flexible component and the outer section comprises the absorbing agent.

The tear strength of the flexible component should preferably be higher than the tear strength of the absorbing agent. High tear strength resistant components for the inner section are generally preferred.

The absorbing agent may be fixed to a flexible fibre by physical interactions or it may be bonded to it chemically. The fibre can comprise only one filament or a bundle of filaments or fibres. The fibre(s) can comprise a metal like Gold, Platinum, stainless steel or an organic substance such as cotton.

In this respect, FIG. 4 shows a particular retraction device according to the invention in cross-section (x- and y-direction). The retraction device (3) comprises two portions (1 and 2). Portion (1) comprises the absorbing agent (4) and has a wedged shape with an apical site. Portion (2) comprises a material with different properties (e.g. with regard to texture and/or absorbing capacity) compared to portion (1) and has a flat coronal site. Portion (1) can be further characterized as having an inner and an outer section. Embedded in portion (1) is a flexible component (5) comprising a non-absorbing material such as a metal fibre or filament.

In a further embodiment, the retraction device as a whole has a colour being different from red or white. This allows an easy detection in the patient's mouth (especially from oral tissue and/or tooth substance) and control if after the treatment the entire retraction device has been removed from the sulcus. Blue, green or violet colours were found to be suitable. Colouring the retraction device can be achieved by incorporating colorants or pigments (organic and inorganic).

It can be desirable that after sealing a wound, the cord does not stick to the coagulated blood. Thus, the surface of the retraction device is preferably made of or comprises a material, that does not adhere to the mucosa of the patient.

In this respect, a retraction device having a soft and/or slippery surface is preferred. This could help removing the cord without opening the wound and the danger of bleeding.

In one embodiment, a slippery surface is achieved upon using the device, that is when it is contacted with moisture or fluid present in the patient's mouth.

In another embodiment the retraction device comprises a softening agent, like water or glycerine. The amount of softening agent is usually below about 60% or below about 40% or even below about 20% compared to the total uptake capacity of the absorbing agent in order to ensure sufficient fluid uptake in the gingival sulcus.

In a further embodiment the retraction device comprises one or more haemostatic agents. Haemostatic agents (sometimes also referred to as astringent agents) that may be useful in assisting haemostasis include, but are not limited to aluminum compounds such as potassium aluminum sulfate, aluminum ammonium sulfate, aluminum sulfate, aluminum chlorohydrate, aluminum acetate, other water soluble astringent aluminum salts, and mixtures thereof. Another class of astringent agents includes iron-based compositions such as ferric salts, including but not limited to ferric sulfate, ferric subsulfate, ferric chloride, and mixtures thereof. Other astringents include permanganates, tannins and zinc chloride.

In yet another embodiment, the dental retraction device comprises an anti-microbial agent. This might help reducing health risks for professionals in the dental offices and laboratories as well as for patients caused by bleeding prior impression taking caused by drilling or retracting the gingival cuff. It may reduce the risk of contamination of the patient having a wound as well as the risk of contamination of the impression taken, thus preventing contamination of dental professionals in the dental office as well as of the dental lab.

To provide an efficient and time-saving solution the retraction device may contain the anti-microbial component when delivered to the dentist. In addition this device may also contain an astringent agent.

It can be beneficial, if residues of the retraction device which accidentally were left in the sulcus do not interfere with or negatively affect the setting reaction of the impression material used after the retraction procedure.

It is known that some haemostatics which are used in solution or together with retraction cords (the cord may be impregnated or soaked in the solution prior use) can compromise the setting reaction of certain impression materials.

For instance, as indicated in the instruction of use of certain 3M ESPE polyether impression materials epinephrine (adrenaline), 8-hydroxyquinoline sulfate or iron (III) sulfate may impair the setting behaviour.

Therefore, it can be an advantage, if the anti-microbial agent used is compatible with the impression material and does not compromise the setting behaviour thereof.

Useful anti-microbial agents which may be used in combination with the retraction device include amino group containing organic anti-microbial agents, halogen containing organic anti-microbial agents, cationic surfactants, mono- and polyhydric phenols, anti-microbial peptides, bactericins, antibiotics, aldehydes p-hydroxy benzoates or parabenes, lauricidin, enzymes, proteins, fluoride, EDTA or natural oils with anti-microbial properties.

Furthermore, it can be advantageous to use combinations of anti-microbial compounds to generate an additive or synergistic effect.

Useful combinations include chlorhexidine or derivatives thereof and aldehydes (glutaraldyde, phtaldehyde) and chlorhexidine or its derivatives and salts of phenolics or acids. It can also be preferred to use acid adducts of chlorhexidine or its derivatives like e.g., acetates, chlorides, nitrates, sulfates or carbonates.

Chlorhexidine and its derivatives (hereinafter referred to as CHX) are commercially available in water-based solutions (e.g. a 20% aqueous solution of CHX digluconate, CAS 18472-51-0) or as a pure compound or as a salt. As additive to non-water based impression materials the pure compound (CAS 55-56-1) and CHX salts like CHX diacatate monohydrate (CAS 56-95-1) or CHX dihydrochloride (CAS 3697-42-5) are preferred.

CHX also seems to be especially suited as an additive due in part to its well-known and proven anti-microbial action against Gram positive and Gram negative microorganisms including the oral Streptococci and Lactobacilli. CHX is bacteriostatic for Mycobaterium. CHX is also active against yeasts including Candida albicans and viruses including HIV, HBV, HCV, Influenza- and Herpes virus. A further advantage of CHX is its low toxicity.

Preferred anti-microbial agents include: Hexitidin, Cetypyridiniumcloride (CPC), Chlorhexidin (CHX), Triclosan, Stannous Chloride, Benzalkonium Chloride, non-ionic or ionic surfactants (e.g. quarternary ammonium compounds), alcohols [monomeric, polymeric, mono-alcohols, poly-alcohols (e.g. Xylitol, Sorbitol), aromatic (e.g. phenol)], antimicrobial peptides (e.g. histatins), bactericins (e.g. nisin), antibiotics (e.g. tetracycline), aldehydes (e.g. glutaraldehyde) inorganic and organic acids (e.g. bencoic acid, salicylic acid, fatty acids) or there salts, derivative of such acids such as esters (e.g. p-hydroxy benzoate or other parabenes, lauricidin), enzymes (e.g. lysozyme, oxidases), proteins (e.g. enamel matrix protein, proline rich proteins), fluoride, EDTA, essential oils (e.g. thymol).

An example of an useful combination of anti-microbial agent and astringent agent is aluminium chloride or partially neutralized aluminium chloride and CHX dichloride.

In another embodiment a vasoconstrictor such as epinephrine and/or propylhexedrine can be added.

The agents mentioned above can be incorporated in the retraction device. This can be achieved by spraying the substance on the device or dipping the device into a composition containing a haemostatic agent or other additive. Another possible way of incorporation is soaking the retraction device in a solution containing the haemostatic agent followed by drying. Those agents or additives can be present in an amount of about 0.05 g/cm to about 0.1 g/cm retraction device.

When in contact with moisture or fluid in the oral cavity, the moisture or fluid is absorbed by the absorbing agent and the haemostatic agent can be released.

The retraction device should preferably be made of or comprise only non-toxic substances. A substance is classified as non-toxic, if its intended use does not negatively affect the patient's health.

Substances which can be used as absorbing agent include at least one of the following substances or derivatives thereof: polyvinyl alcohol, polyurethane, polystyrene, polyolefin, polyvinyl chloride, latex, silicone, fluorpolymer, starch or cellulose.

Substances found to be especially useful as absorbing agent are e.g. polyvinyl alcohol derivatives. The polyvinyl alcohol derivatives can be acetylized. Especially useful are polyacetales. An commercially available polyvinyl alcohol derivative is sold under the trademark Merocel™, manufactured by Xomed Inc., USA.

Manufacturing and properties of such a material is described e.g. in U.S. Pat. No. 4,098,728. The material can be made by reacting formaldehyde with polyvinyl alcohol under specific conditions.

Preferred polyvinyl alcohols for producing the polyvinyl alcohol derivatives are the medium molecular weight range polyvinyl alcohols, if improvement of the uniformity of the pore size is desired. Generally, the medium molecular weight polyvinyl alcohols have an average molecular weight of between about 35,000 and about 45,000, more usually between about 39,000 and about 42,000.

Also open cell foam of polyvinylalcohol or esterified or partially esterified polyvinylalcohol might be used. The structure of a retraction device comprising e.g. polyvinyl alcohol derivatives may primarily be composed of hydrophilic fibres.

The desired expansion behaviour of the retraction device can be achieved by different means.

In one embodiment the retraction device comprises an inner flexible cord surrounded by an expandable component.

According to another embodiment the retraction device can be prepared by drying a wet retraction cord under compression, e.g. under radial compression.

It is also possible to have a fibre made out of the absorbing agent which is interwoven with one or more cords comprising a non-expandable component.

All these cases might result in a completely or partially dried retraction device that expands essentially in radial direction (x- and/or y-direction).

The invention is also directed to a kit of parts comprising a retraction device as defined in the text and a curable impression material, the setting behaviour of which is not negatively affected if cured in the presence of the retraction device.

The impression materials which can be used in combination with retraction devices are not particularly limited in regard to their chemistry and nature. Polyether moieties or silicone moieties containing impression materials have been found to be useful.

Examples of polyether moieties containing impression materials are given in U.S. Pat. No. 6,383,279 (3M ESPE), US 2002/0156149 (HeraeusKulzer) and US 2005/02503871 (Kettenbach). Commercially available materials are sold e.g. under the brand Impregum™.

The kit can further comprise accessories like retraction caps. Retraction caps can be useful for keeping the retraction device in place until an impression is taken. Retraction caps can be made of soft, tissue friendly material, e.g. cotton. However, other materials might be useful as well. If appropriate a temporary restoration can be used as retraction cap, too. Commercially available retraction caps are e.g. sold under the brand Comprecap™ (Coltene Whaledent).

The invention is also directed to a method of using an absorbing agent as described in the text of the invention for producing a dental retraction device, the retraction device having the shape of a cord with a radial (x- and y-direction) and longitudinal direction (z-direction) and comprising an expandable component, wherein the retraction device is able to expand in the radial direction (x- and/or y-direction), but essentially does not expand in the longitudinal direction (z-direction) upon contact with moisture.

A possible method of using the retraction device of the invention in the dental practice comprises the step of a) providing the retraction device with a suitable length and b) wrapping the retraction device round a prepared tooth structure or inserting the retraction device in the sulcus of a prepared tooth structure. Further steps can be: c) allowing the retraction device to swell and d) removing the retraction device after swelling from the sulcus.

In this respect FIG. 5a shows a schematic view of a tooth structure (5) with gingiva (6) and sulcus (7). “A” represents the area where the retraction device should be placed. FIG. 5b shows the placement of a retraction device (3) according to the invention using an application instrument (8).

Another embodiment is shown in FIGS. 6a and 6b. A cord shaped expandable retraction device (3) is placed in the sulcus (7) using an application instrument (8) (FIG. 6a). When contacted with fluid the retraction device starts expanding and adapting its shape to the environment and removing the gingiva (6) from the tooth structure (5). After a certain amount of time (e.g. about 1 to 15 min or about 2 to about 10 min after placement), the retraction device (3) can be removed as a whole from the sulcus (7) with another instrument (9) e.g. a pincer (FIG. 6b). As can be seen, the shape and size of the retraction device has changed and the sulcus has been widened.

Application of the retraction device can also be done using a device that holds the retraction device in place after placement, such as a retraction cap. Useful equipment is commercially available, e.g. Comprecap™. Another possibility is using a temporary restoration.

The retraction device of the invention is preferably provided to the practitioner under hygienic conditions. One possibility to achieve this is packing the retraction device in a sealed container or foil bag under hygienic conditions.

### EXAMPLES

### Measurement of Swelling Pressure

The measurement was performed at 23° C.+/−1° C. using a fine calibrated force sensor of a dynamic stress rheometer (Physica MCR300, Anton Paar) and a plate-plate (diameter 20.0 mm) geometry. The gap between the plates was kept constantly at 0.5 mm. The test specimens were placed in a manner that expansion (increase in thickness due to swelling) occurs in the direction of the plates. Then the measurement was started recording the normal force. 10 s after start of the measurement excess of deionized water was added (1 ml). Data was collected over a period of 3 min. The surface area considered in the measurement was 40 mm² for all tested specimen. Thickness of the specimen was 0.3 mm. The dimensions of the specimen in length and width were 20.0 mm and 2.0 mm, respectively.

The test specimens were made by compressing different samples of polyvinylalcohol derivatives having e.g. a different pore size and of varying heights (but keeping length and width of the samples constant: 20.0 mm and 2.0 mm) to a uniform height of 0.3 mm. Water uptake during the measurement resulted in swelling of the individual specimen in height which caused a swelling pressure. The maximum swelling pressure measured for the tested specimen is given in Table 1. What can be seen is, that the measured swelling pressure can be influenced by the thickness of the samples prior to compressing and also by the nature of the samples used (e.g. with regard to chemical composition, pore volume, etc.).

TABLE 1
Measured swelling pressure [kPa].

| | Thickness of sample prior to | |
|---|---|---|
| Entry | compressing [mm] | max. swelling pressure [kPa] |
| 1 | 3.0 | 42.3 |
| 2 | 8.0 | 300.0 |
| 3 | 8.0 | 136.1 |

### Preparation of a Retraction Device Containing a Retarding Agent

An Eudragit™ E 100 containing solution was prepared by stirring 10 g polymer granulate of Eudragit™ E 100 (cationic copolymer based on dimethylaminoethyl methacrylate and neutral methacrylic esters, approximate average molecular weight Mw 150,000; Röhm, Darmstadt) in 100 ml acetone for 10 minutes at 23° C.

A test specimen was made from a compressed sample of a polyvinylalcohol derivative with a uniform height of 0.3 mm and weight of 0.022 g. The surface was coated with the retarding agent by dipping the sample two times for 2 seconds into the above described Eudragit™ E containing solution. Thereafter the sample was dried for 10 min at room temperature. After solvent evaporation the sample was covered by a film of retarding agent. The test specimen contained about 10 wt.-% Eudragit™ relative to the unprepared sample.

### Measurement of Delayed Expansion

Water uptake during the measurement resulted in swelling of the individual specimen in height which caused a swelling force. The measurement of swelling force was performed at 23° C.+/−1° C. using a fine calibrated force sensor of a dynamic stress rheometer (Physica MCR300, Anton Paar) and a plate-plate (diameter 20.0 mm) geometry. The gap between the plates was kept constantly at 0.5 mm.

The test specimens were placed in a manner that expansion (increase in thickness due to swelling) occurs in the direction of the plates. Then the measurement was started recording the normal force. Ten seconds after start of the measurement excess of deionized water was added (1 ml) for measurement of the retraction device without a retarding agent.

For the analysis of the expanding behaviour of the retraction device containing the retarding agent, 0.5 ml deionized water was added in a first step and after 1 min 0.5 ml 1N hydrochloric acid (Bernd Kraft, Duisburg) was added in a second step. Data was collected over a period of 10 min. The surface area considered in the measurement was 66 mm² for all tested specimen. Thickness of the specimens exclusive the retarder coating was 0.3 mm. The dimensions of the specimen in length and width were 20.0 mm and 3.3 mm, respectively.

FIG. 7 graphically shows the delayed expansion determined. The light gray curve represents the expansion behaviour of the retraction device comprising an absorbing agent and a retarding agent. The black curve represents the expansion behaviour of a retraction device comprising an absorbing agent but no retarding agent.

1. A dental retraction device to be used for retracting gingiva from tooth structure, the retraction device having a cord shape with a radial (x- and y-direction) and a longitudinal direction (z-direction) and comprising an absorbing agent and a retarding agent, wherein the retraction device is able to expand in the radial direction (x- and/or y-direction), but essentially does not expand in the longitudinal direction (z-direction) upon contact with a fluid.

2. The retraction device of claim 1, wherein the ratio of longitudinal expansion to radial expansion is greater than about 1 to about 10.

3. The retraction device of claim 1, wherein the absorbing agent is able to absorb up to about 1 ml of fluid.

4. The retraction device of claim 1 comprising one or more of the following components: haemostatic agent, softening agent, anti-microbial agent and/or colorants.

5. The retraction device of claim 4, wherein the softening agent is selected from the group consisting of water or glycerine.

6. The retraction device of claim 1, wherein the absorbing agent has the shape of a sponge, a solid foam or a woven or non-woven fabric.

7. The retraction device of claim 1, wherein the absorbing agent comprises at least one of the following substances or its derivatives: polyvinyl alcohol, polyurethane, polystyrene, polyolefin, polyvinyl chloride, latex, silicone, fluorpolymer, starch or cellulose.

8. The retraction device of claim 1, comprising a cross-section that at least in part has the shape of a square, a rectangle, a triangle, a circle, an ellipsoid, a wedge or of the symbol T.

9. The retraction device of claim 1 comprising a first and a second portion, the first portion having properties being different from the properties of the second portion with regard to geometry and/or physical and/or chemical properties.

10. The retraction device of claim 1 comprising an inner section and an outer section, wherein the inner section comprises a flexible component and the outer section comprises the absorbing agent.

11. The retraction device of claim 10, wherein the flexible component comprises a fibre comprising a metal and/or an organic substance.

12. The retraction device of claim 1, wherein the cord-shaped retraction device has a coiled or curled structure with respect to the z-direction.

13. The retraction device of claim 1, the properties with regard to shape and structure being adjusted such that a defined sample of the retraction device (length=20.0 mm, width=2.0 mm, height=0.3 mm) can exert a pressure of at least about 10 kPa during or at the end of the expanding process, when the retraction device is soaked with a defined amount of water (1 ml) between parallel plates (diameter 20 mm, gap distance 0.5 mm) of a dynamic stress rheometer.

14. The retraction device of claim 1, wherein the retarding agent comprises a material selected from the group consisting of naturally film forming agents, semi-synthetic film forming agent, cellulose and derivatives of cellulose, poly(meth)acrylates and vinylpolymers.

15. The retraction device of claim 1, wherein the retarding agent is incorporated in the retraction device or placed on the surface of the retraction device.

16. A kit of parts comprising a retraction device as defined in claim 1 and an initiator solution, the initiator solution being able to compensate for or inhibit the retarding effect caused by the retarding agent.

17. A kit of parts comprising a retraction device as defined in claim 1 and a curable impression material, the setting behaviour of which is not negatively affected if cured in the presence of the retraction device.

18. A method for producing a dental retraction device as defined in claim 1, the method comprising the step of
drying the wet retraction device under radial compression (x- and/or y-direction) or
interweaving the absorbing agent with a flexible component, which is a non-expandable cord.

19. (canceled)
